(19) United States
(12) Patent Application Publication
(10) Pub. No.: US 2017/0316663 A1
(43) Pub. Date: Nov. 2, 2017

(54) MONITOR FOR DYNAMIC DISPLAYING

(71) Applicant: National Taipei University of Technology, Taipei City (TW)

(72) Inventors: Shaw Hwa HWANG, Taipei City (TW); Bing Chih YAO, Taipei City (TW); Kuan Lin CHEN, Taipei City (TW); Yao Hsing CHUNG, Taipei City (TW); Chi Jung HUANG, Taipei City (TW); Cheng Yu YEH, Taipei City (TW); Shun Chieh CHANG, Taipei City (TW); Li Te SHEN, Taipei City (TW); Chao Ping CHU, Taipei City (TW); Ning Yun KU, Taipei City (TW); Tzu Hung LIN, Taipei City (TW); Ming Che YEH, Taipei City (TW)

(21) Appl. No.: 15/143,658

(22) Filed: May 2, 2016

(51) Int. Cl. G08B 13/196

(52) U.S. Cl. CPC G08B 13/19678; G08B 13/19602; G08B 13/19645

(57) ABSTRACT

The present invention provides a monitor for dynamic displaying. K cameras are connected with the monitor in order to display images recorded by the k cameras on a screen of the monitor. An “abnormality detection algorithm” is used for detecting abnormalities of the images recorded by the k cameras. Those images having abnormalities are displayed continuously on the screen, other images having no abnormality are not displayed, so that a security service personnel can watch those images having abnormalities on the screen to enable appropriate action quickly.

### FIELD OF THE INVENTION

The present invention relates to a special monitor for security service, and more particularly to a monitor for security service which can select those images having abnormalities for displaying.

### BACKGROUND OF THE INVENTION

Referring to FIG. 1, which shows schematically a conventional multiplex monitor for security service, the monitor 5 will display images recorded by several or dozens of cameras on screen thereof simultaneously. The screen of the monitor 5 in FIG. 1 is equally divided into four pictures 6, 7, 8, 9 for displaying images recorded by cameras 1, 2, 3, 4 respectively. The security service personnel watch the four pictures on the monitor 5 for surveying everywhere in order to enable appropriate action quickly.

If the screen of the monitor 5 is divided into dozens of pictures, then each picture is very small, therefore the security service personnel sometimes cannot sense the abnormalities in the pictures, and cannot enable appropriate action quickly.

### SUMMARY OF THE INVENTION

The object of the present invention is provides a monitor for dynamic displaying. K cameras are connected with the monitor in order to display images recorded by the k cameras on a screen of the monitor. An “abnormality detection algorithm” is used for detecting abnormalities of the images recorded by the k cameras. Those images having abnormalities are displayed continuously on the screen, other images having no abnormality are not displayed, so that the security service personnel can watch those images having abnormalities on the screen to enable appropriate action quickly.

The “abnormality detection algorithm” first obtains a background image from each camera, and then obtains a present image from each camera; both the background image and the present image have n×m pixels; a first value of each pixel of the present image is subtracted correspondingly by a second value of each pixel of the background image, and then get an absolute value thereof; those n×m absolute values are sumed up for being divided by n×m to get a Dₘₑₐₙ; a reasonable “abnormality detecting threshold” D_{threshold} is set in advance; if Dₘₑₐₙ>D_{threshold}, then there is abnormality, the present image is displayed on the screen of the monitor; otherwise the present image is not displayed on the screen of the monitor.

### BRIEF DESCRIPTION OF THE DRAWINGS

FIG. 1 shows schematically a conventional multiplex monitor for security service.

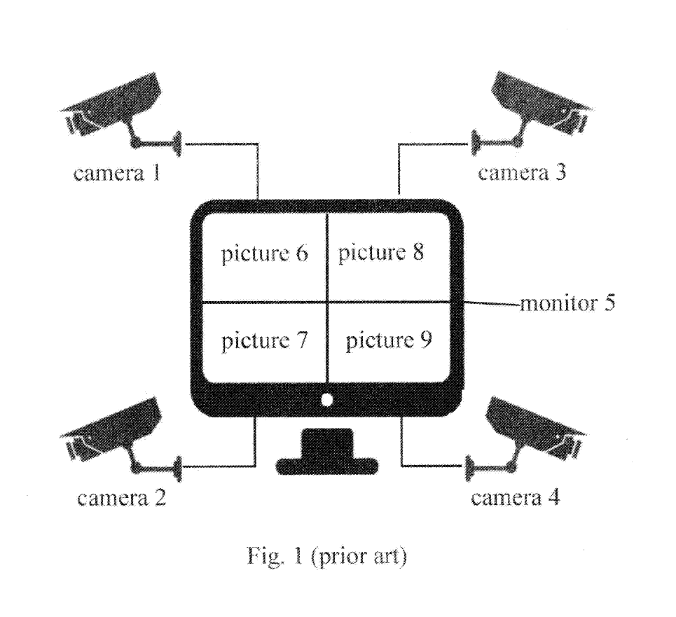

FIG. 2 shows schematically a monitor for dynamic displaying according to the present invention.

FIG. 3 shows schematically a special condition of the monitor for dynamic displaying according to the present invention.

FIG. 4 shows schematically another condition of the monitor for dynamic displaying according to the present invention.

FIG. 5 shows schematically a further condition of the monitor for dynamic displaying according to the present invention.

FIG. 6 shows schematically a flow chart of the related program in the monitor for dynamic displaying according to the present invention.

FIG. 7 shows schematically the “abnormality detection algorithm” according to the present invention.

FIG. 8 shows schematically an example to describe “abnormality detection algorithm” according to the present invention.

### DETAILED DESCRIPTIONS OF THE PREFERRED EMBODIMENTS

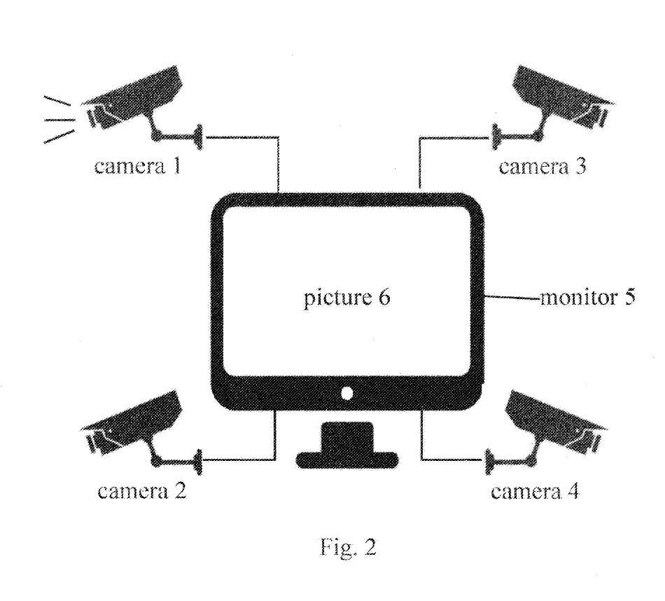

Referring to FIG. 2, which shows schematically a monitor for dynamic displaying according to the present invention. In order to enable the security service personnel to sense the abnormalities in the pictures quickly, the monitor 5 is designed to use an “abnormality detection algorithm” for detecting the abnormalities of the pictures recorded by the cameras. If one picture of the cameras has abnormality, then the monitor 5 only displays said picture, other pictures having no abnormality will not be displayed.

For example, in FIG. 2, the picture 6 of the camera 1 has abnormality, other pictures 7, 8, 9 of the cameras 2, 3, 4 have no abnomalities, therefore the monitor 5 only displays the picture 6 of the camera 1, other pictures 7, 8, 9 of the cameras 2, 3, 4 will not be displayed. Thus the security service personnel can clearly sense the abnormality in the picture 6 of the camera 1, and enable appropriate action quickly.

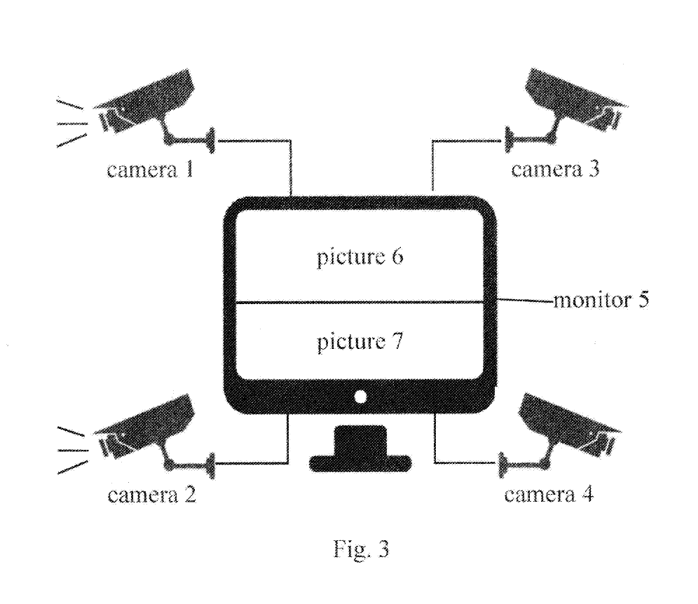

Referring to FIG. 3, the pictures 6, 7 of the cameras 1, 2 have abnomalities, other pictures 8, 9 of the cameras 3, 4 have no abnomalities, therefore the monitor 5 only displays the pictures 6, 7 of the cameras 1, 2, other pictures 8, 9 of the cameras 3, 4 will not be displayed. Thus the security service personnel can clearly sense the abnormalities in the pictures 6, 7 of the cameras 1, 2, and enable appropriate action quickly.

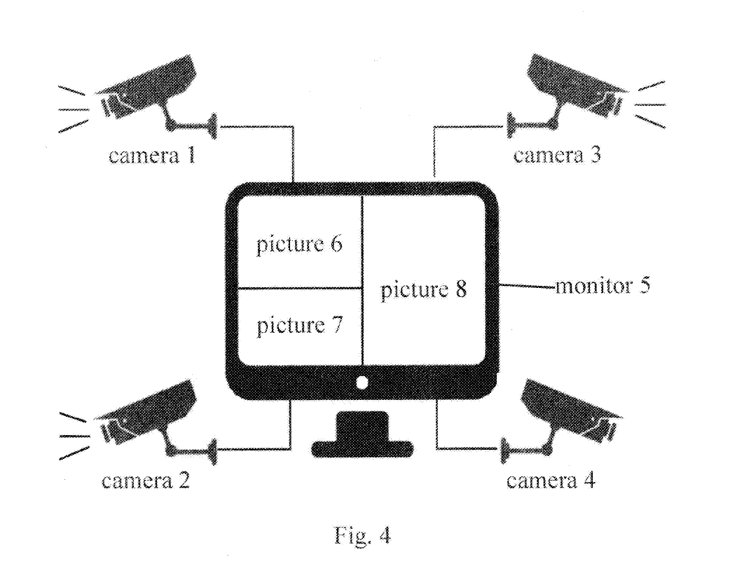

Referring to FIG. 4, the pictures 6, 7, 8 of the cameras 1, 2, 3 have abnomalities, other picture 9 of the camera 4 has no abnormality, therefore the monitor 5 only displays the pictures 6, 7, 8 of the cameras 1, 2, 3, other picture 9 of the camera 4 will not be displayed. Thus the security service personnel can clearly sense the abnormalities in the pictures 6, 7, 8 of the cameras 1, 2, 3, and enable appropriate action quickly.

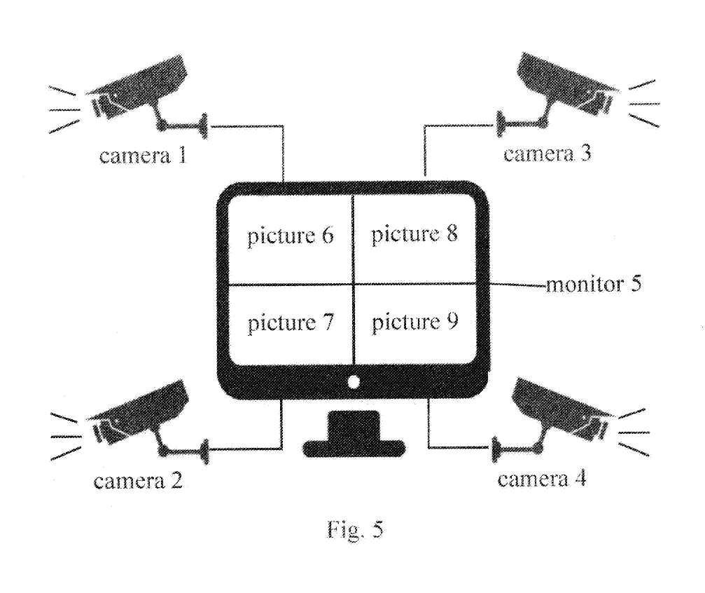

Referring to FIG. 5, the pictures 6, 7, 8, 9 of the cameras 1, 2, 3, 4 have abnomalities, therefore the monitor 5 displays the pictures 6, 7, 8, 9 of the cameras 1, 2, 3, 4. Thus the security service personnel must carefully sense the abnormalities in the pictures 6, 7, 8, 9 of the cameras 1, 2, 3, 4, and enable appropriate action.

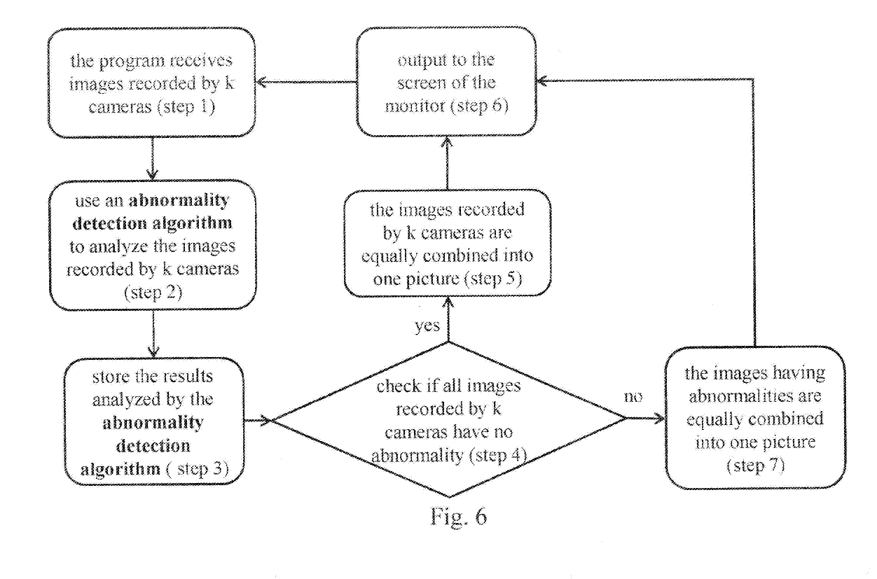

Referring to FIG. 6, which shows schematically a flow chart of the related program in the monitor for dynamic displaying according to the present invention. In step 1, the program of the monitor 5 receives images recorded by k cameras. In step 2, the program of the monitor 5 uses an “abnormality detection algorithm” to analyze the images recorded by k cameras. In step 3, the program of the monitor 5 stores the results analyzed by the “abnormality detection algorithm”. In step 4, the program checks that if all images recorded by k cameras have no abnormality; if no abnormality at all, then the images recorded by k cameras are equally combined into one picture (step 5), and outputted to the screen of the monitor 5 (step 6), go back to step 1 for proceeding repeatedly; if there are abnormalities, then the images having abnormalities are equally combined into one picture (step 7), and outputted to the screen of the monitor 5 (step 6), go back to step 1 for proceeding repeatedly.

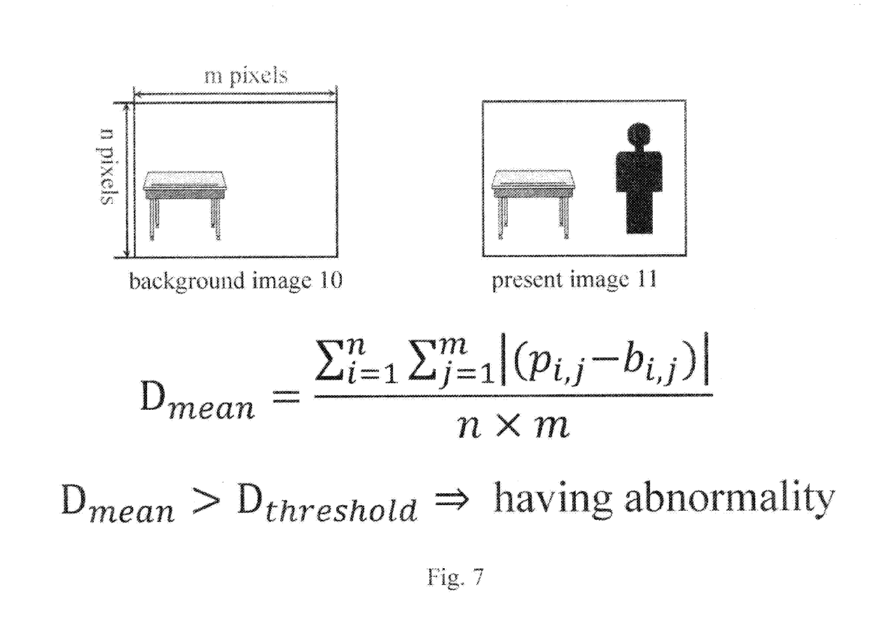

Referring to FIG. 7, which shows schematically the “abnormality detection algorithm” according to the present invention; At first the program of the monitor 5 obtains a background image 10 from each camera. The background image 10 is the first image recorded by each camera or a previous image recorded by each camera. Thereafter the program of the monitor 5 obtains a present image 11 from each camera. Both the background image 10 and the present image 11 have n×m pixels. The value p_{i,j} of each pixel of the present image 11 is subtracted correspondingly by the value b_{i,j} of each pixel of the background image 10, and then get the absolute value thereof. The n×m absolute values are sumed up for being divided by n×m to get Dₘₑₐₙ, as shown by the formula in FIG. 7.

The program of the monitor 5 will set in advance a reasonable “abnornmality detecting threshold” D_{threshold}. If Dₘₑₐₙ>D_{threshold}, then there is abnormality, the program of the monitor 5 will display said present image 11 on the screen of the monitor 5.

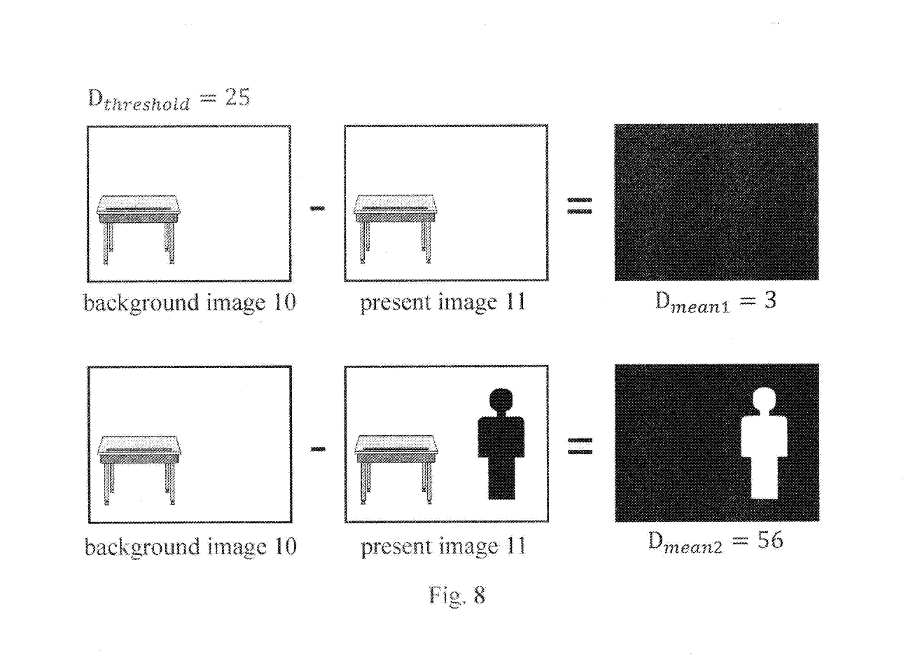

Referring to FIG. 8, taking an example to describe “abnormality detection algorithm” according to the present invention. The program of the monitor 5 sets in advance a reasonable “abnormality detecting threshold” D_{threshold} to be 25. If the background image 10 is almost the same as the present image 11, as shown in the upper part of FIG. 8, then Dₘₑₐₙ calculated by the “abnormality detection algorithm” is 3, which is smaller than 25, so there is no abnormality. If the present image 11 appears a figure of a man, as shown in the lower part of FIG. 8, then Dₘₑₐₙ calculated by the “abnormality detection algorithm” is 56, which is greater than 25, so there is abnormality.

The scope of the present invention depends upon the following claims, and is not limited by the above embodiments.

What is claimed is:

1. A monitor for dynamic displaying, k cameras are connected with the monitor in order to display images recorded by the k cameras on a screen of the monitor; an “abnormality detection algorithm” is used for detecting abnormalities of the images recorded by the k cameras; those images having abnormalities are displayed continuously on the screen, other images having no abnormality are not displayed.

2. The monitor for dynamic displaying according to claim 1, wherein the “abnormality detection algorithm” first obtains a background image from each camera, and then obtains a present image from, each camera; both the background image and the present image have n×m pixels; a first value of each pixel of the present image is subtracted correspondingly by a second value of each pixel of the background image, and then get an absolute value thereof, those n×m absolute values are sumed up for being divided by n×m to get a Dₘₑₐₙ; a reasonable “abnormality detecting threshold” D_{threshold} is set in advance; if Dₘₑₐₙ>D_{threshold}, then there is abnormality, the present image is displayed on the screen of the monitor; otherwise the present image is not displayed on the screen of the monitor.
